(19) United States
(12) Patent Application Publication
(10) Pub. No.: US 2015/0051990 A1
(43) Pub. Date: Feb. 19, 2015

(54) System for sale and automatic delivery of products in movie theaters during a film screening

(71) Applicants: Nazar Bubley, Lviv (UA); Teodor Hryvna, Lviv (UA)

(72) Inventors: Nazar Bubley, Lviv (UA); Teodor Hryvna, Lviv (UA)

(21) Appl. No.: 13/967,368

(22) Filed: Aug. 15, 2013

(51) Int. Cl. G06Q 10/08; G06Q 50/12

(52) U.S. Cl. CPC G06Q 10/087; G06Q 50/12
USPC 705/15

(57) ABSTRACT

The invention is the system for sale and automatic delivery of products in movie theaters during a film screening. The invention allows movie theaters' visitors to see information about, choose, order, pay and after that have automatically delivered directly to their seat in movie theater auditorium different products, such as drinks, popcorn and snacks. The key advantage given by the invention is movie theaters' visitors possibility to have these products bought and delivered during the film screening, without a need to interrupt a movie and go to concession stand. Embodiments of the invention are carried out as a complex of means for ordering and payment for products and also means for automatic delivery of ordered products.

### RELATED APPLICATIONS

This application claims the benefit of U.S. Provisional Application No. 61683309 filed 15 Aug. 2012.

### FIELD OF THE INVENTION

This invention relates in general to a field of retail and more specifically to systems, methods and machines which are used for retail of food and beverages in movie theaters.

### BACKGROUND OF THE INVENTION

The retail industry is a sector of the economy that is comprised of individuals and companies engaged in the selling of finished products to end user consumers. The retail industry is one of the most significant to the world's economy because great part of global GDP is produced by retailers of different types. We can define two types of retailers in the industry. The first one is store retailers—those engaged in the sale of products from physical locations which warehouse and display merchandise with the intent of attracting customers to make purchases on site. The second type is non-store retailers—those engaged in the sale of products using marketing methods which do not include a physical location, for example infomercials (teleshopping), e-commerce, vending machines and multi-level marketing. Both types play very important role in the retail industry. But due to expanding consumer-oriented economy and arising of technology revolution, the traditional in-store retail systems are giving up their market positions to alternative and more comfortable vending machines and e-commerce systems.

Movie theaters, in most of which are located food and beverages retail systems, such as buffets, restaurants and cafés, are relatively small but significant segment of retail industry. Retail in movie theaters is currently a huge area of expansion with many companies offering a wider range of products.

Many people are in the habit of buying snacks every time they see a movie and others buy theater concession food only occasionally, so that movie theaters usually sell various snack foods and drinks at concession stands or kiosks.

Foods usually served at movie theatres include popcorn, soft drinks, nachos, hot dogs, ice creams and a wide range of confectionery.

Some movie theaters forbid eating and drinking inside the viewing room (restricting such activities to the foyer), while others encourage it by fitting cup holders on the arm rests (on the front side of the arm rests of one's own chair, or the back side of the arm rests in front) and selling large portions of popcorn and soft drinks; also in that case bringing one's own food and drinks may be forbidden.

Many theaters have embraced the “brew and view” concept, serving alcoholic beverages, in addition to snacks and popcorn. Some movie theaters offer full restaurant service theaters at one's seat and feature a wider selection than simply snacks and popcorn. These “dine-in” theaters allow patrons to purchase “meals” (ranging from pizza slices to hamburgers and more) that can be consumed while watching the movie, though such model is not as widespread.

But during a more than hundred years of cinema's history, a special consuming culture evolved that makes a trip to a movie incomplete without some goodies, even if it's the kind of goody we might otherwise avoid—particularly at higher than normal prices. Because of that, traditional concessions are by now inextricably linked to the moviegoing experience. In most of movie theaters there are concession stands with hot dogs, popcorn and candies available for purchase.

Whether it is snacks or bigger meals, rushing out to see a film after work without eating first causes many working people to eat at the movie theater. Younger working people attending evening screenings of action films comprise one of the largest segments of eaters at the cinema. There is not only kid-in-a-candy-store excitement—cinema is the only one place where it's still safe to gorge on junk food—but the smell of popcorn that pervades every movie theater can bubble up nostalgia in even the most curmudgeonly customer.

As cinema retail industry developed, prior art of food and beverages retail transformed from concession stands into gourmet coffee bars and café-style concessions with expanded menus that include bottled juices, juice-drinks, bottled waters, and made-to-order pizza in order to satisfy growing demands for variety in dining options. Cinema's restaurant style food and drinks sale facilities sometimes are supplemented with classical vending machines providing coffee, soft drinks and snacks.

Widespread culture of eating and drinking while watching movie in cinema causes long queues near the concession stands before the beginning of the movie and also urges people to interrupt a movie with a walk for buying another portion of food.

### SUMMARY OF THE INVENTION

The system for sale and automatic delivery of products in movie theaters during a film screening has three key objectives:

The first objective is to reduce or eliminate queues which arise when overcrowded concession stands or cafes in movie theaters don't cope with serving great number of people. Sometimes such queues are significant constraints in purchasing desirable products.

The second objective is to relieve people from awkward situations which arise when a person has already eaten a food during a movie screening and still wants more food or drinks, but hesitates to go and buy more, because of reluctance to miss the part of the movie passing back and forth the whole row of seats under the angry glances of viewers, whose movie enjoying process have been interrupted.

The third objective of the system for sale and automatic delivery of products in movie theaters during a film screening is to decrease risks and costs in maintaining of a food and drinks sales system in (concession stand or etc.), making sales process more automatic and decreasing human factor in a process of sale.

The system for sale and automatic delivery of products in movie theaters during a film screening provides movie theater visitors possibility to order, pay and have delivered food, beverages or other products, without a need to go somewhere out of their personal seat in the movie theater auditorium.

The system for sale and automatic delivery of products in movie theaters during a film screening comprising the following elements:

A system for products ordering.

A system for automatic products delivery into an area around a customer's seat.

The system for products ordering comprises of

An electronic device appropriate for running an interface for ordering products.

An interface providing possibility to order products.

A device for receiving a payment.

The interface for ordering products could be customized for every cinema, but basically it performs at the following functions:

Function of product list, informing movie theater visitors about products they can purchase and providing a possibility to choose products they want to purchase.

Function of cashier, providing movie theater visitors possibility to choose products and order them and showing the total amount of money they should pay.

Function of costs withdrawing, being synchronized with payment card reader scanning payment cards and assisting in transfer of costs from payers account to the beneficiary account.

The preferred electronic device to carry out the device for running an interface for ordering products is a tablet computer with touch screen and software interface providing possibility to order products and also synchronized with payment card reader, together performing the function of the device for receiving a payment, and all together comprising the system for products ordering.

The system for automatic products delivery into an area around customer's seat is preferred to be carried out as a combination of a vending machine and delivery containers, where the vending machine receives information about ordered items from the system for item ordering and after that loads ordered products into delivery containers, which are carrying the products through the movie theater's auditorium directly into the area around the seat where the order was made. In some cases products could be loaded into delivery containers manually.

So that, the system for sale and automatic delivery of delivery of products in movie theaters during film screening allows to reach a new level of comfort for visitors of the movie theater, providing them possibility to purchase and consume food and drink while watching the movie, effectively decreasing mental and physical obstacles that were significant in prior art sales technologies.

### BRIEF DESCRIPTION OF DRAWINGS

FIG. 1-4—landscape views of key elements of system for sale and automatic delivery of products, which are installed in the basic movie theater auditorium.

FIG. 5-8—perspective views of key elements of system for sale and automatic delivery of products, which are installed in the basic movie theater auditorium.

FIG. 9-14—views of the products ordering device and of the process of ordering the product by customer.

FIG. 15-16—views of the rack pinion mechanism which is used for the movement of the products ordering device; views of the charging device which is used to charge the products ordering device.

FIG. 17-18—views of the delivery containers on the manual loading points.

FIG. 19-25—views of the inside and outside vending machine.

FIG. 26-29—views of the delivery container.

FIG. 30-33—views of the delivery container moving downstairs in the movie theater auditorium.

FIG. 34-39—the delivery container moving along the row of seats from the customer's point of view; the delivery container on its destination point in area around the customer's seat.

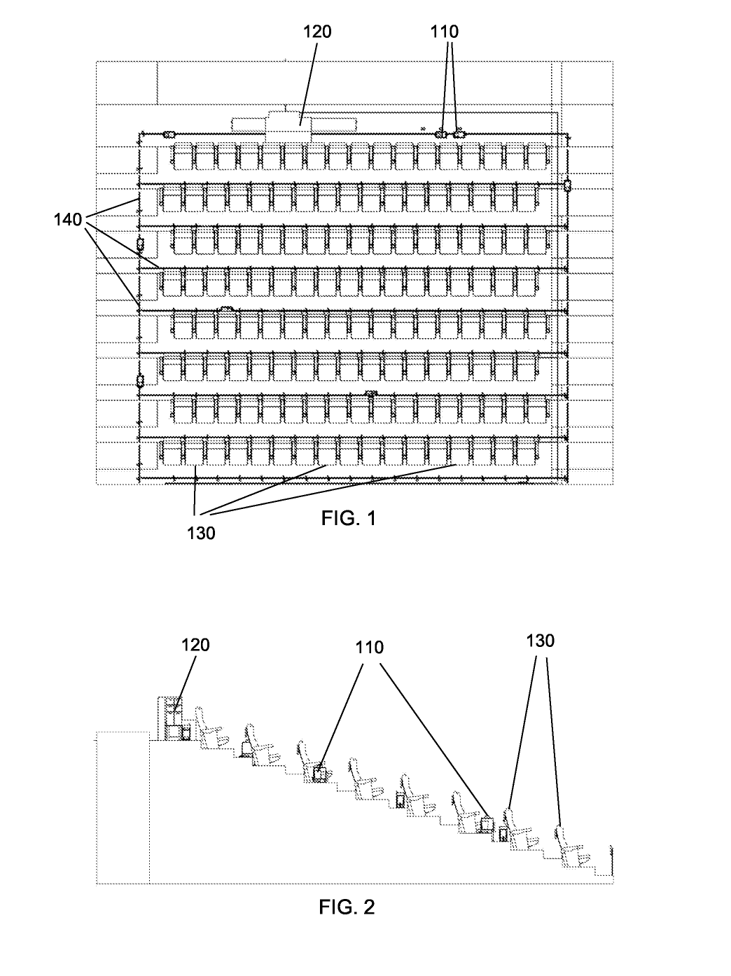

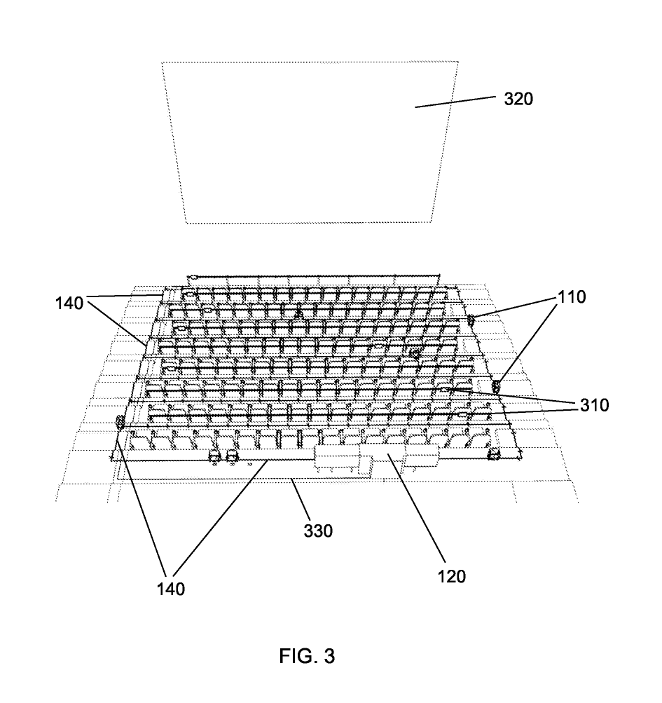

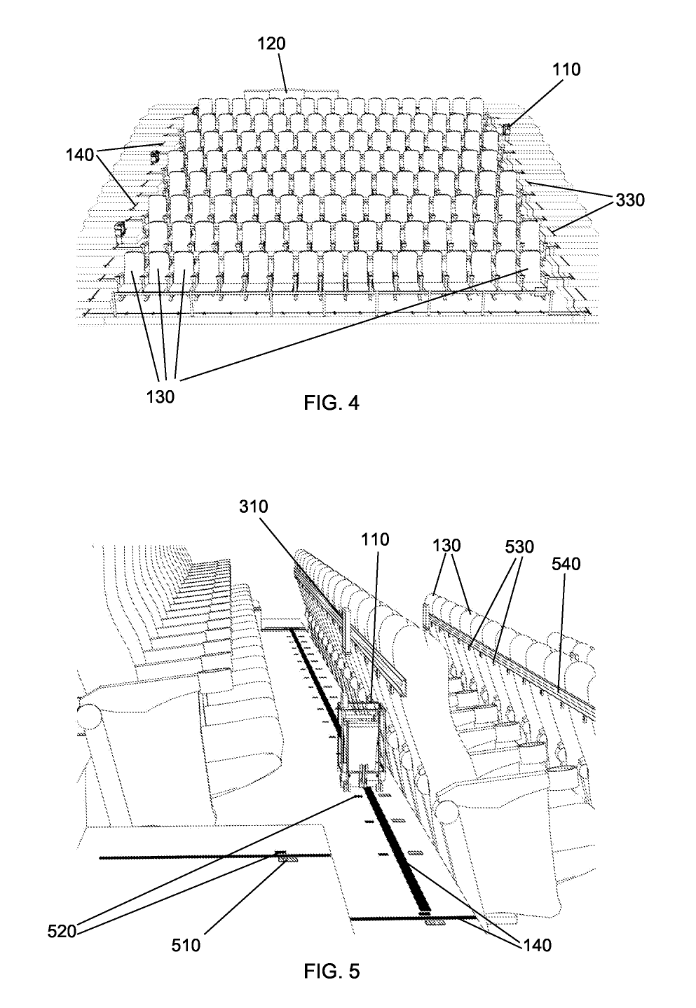

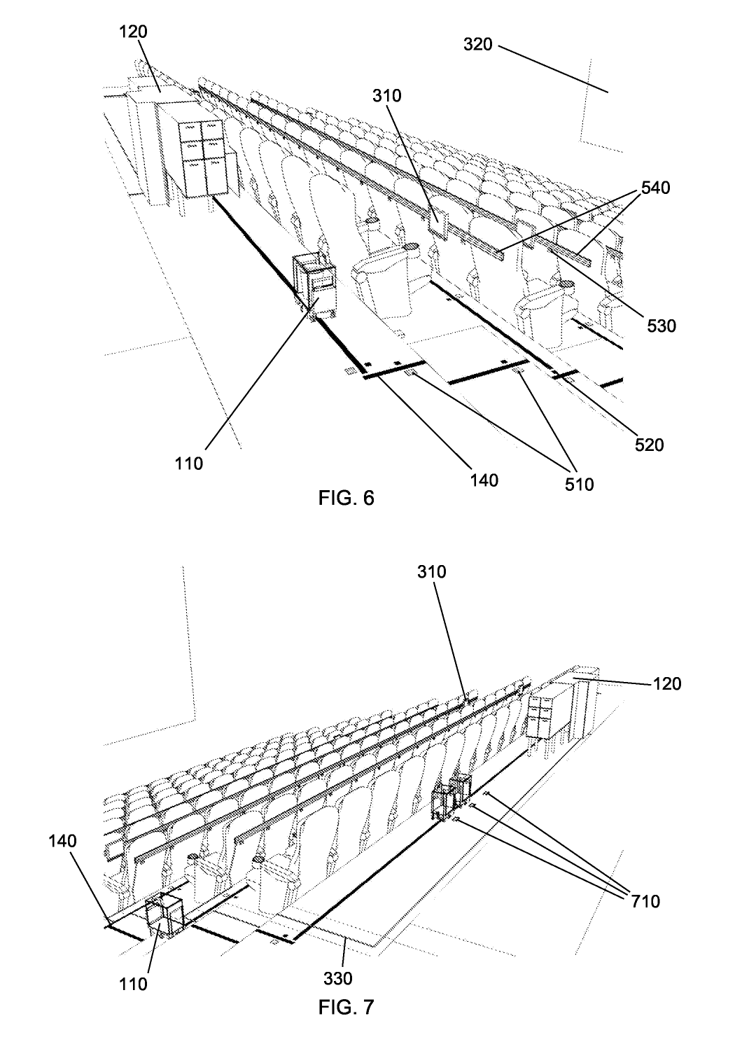

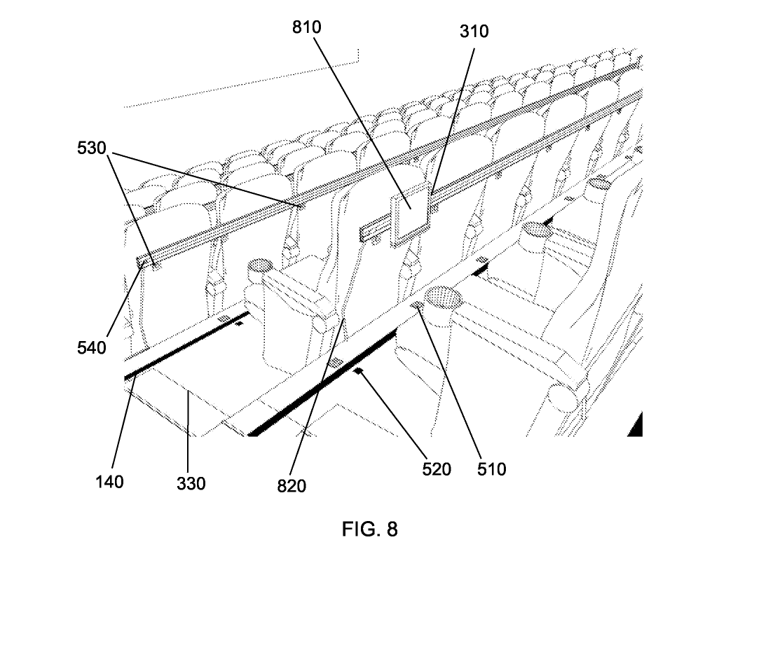

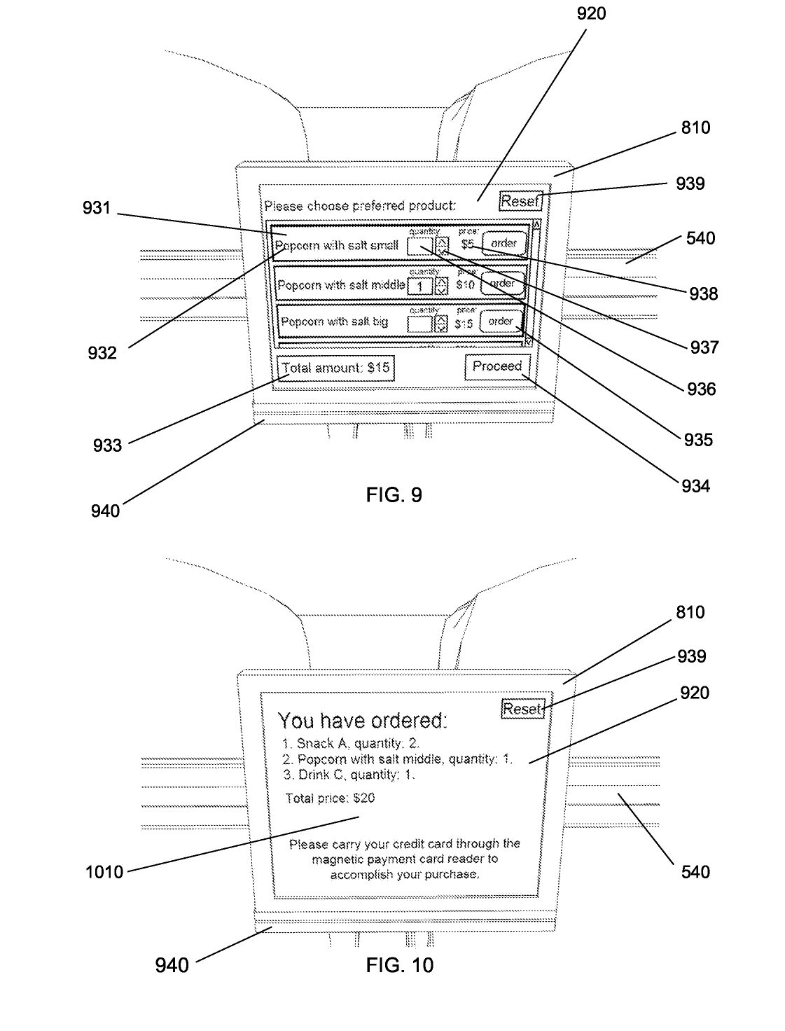

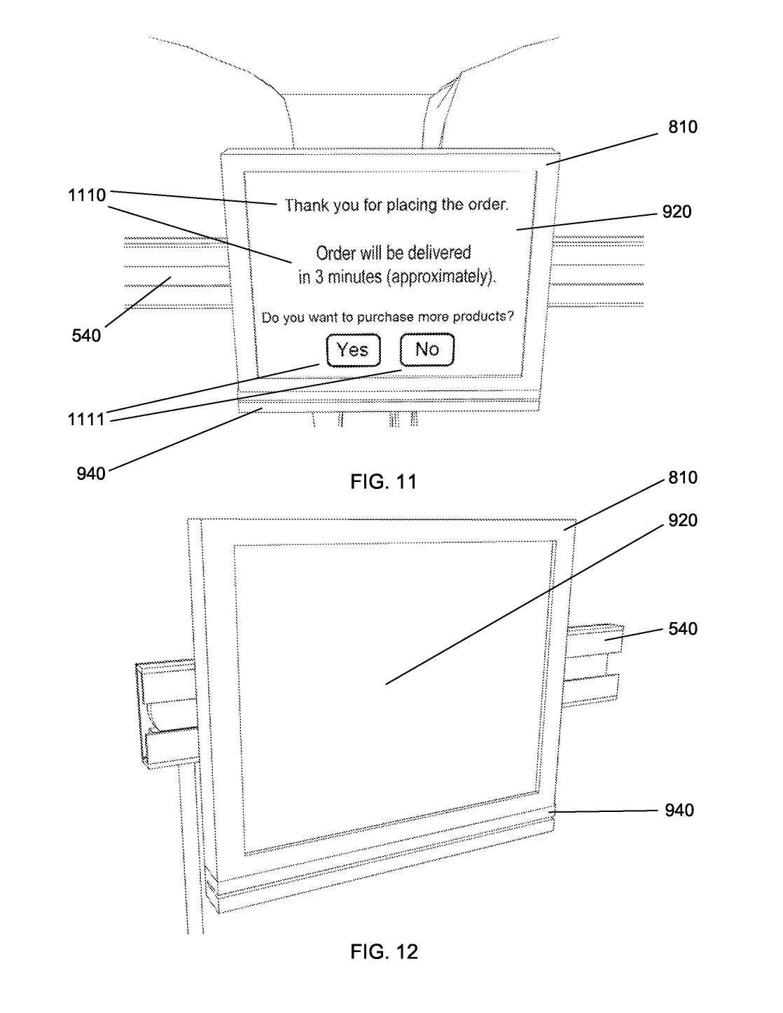

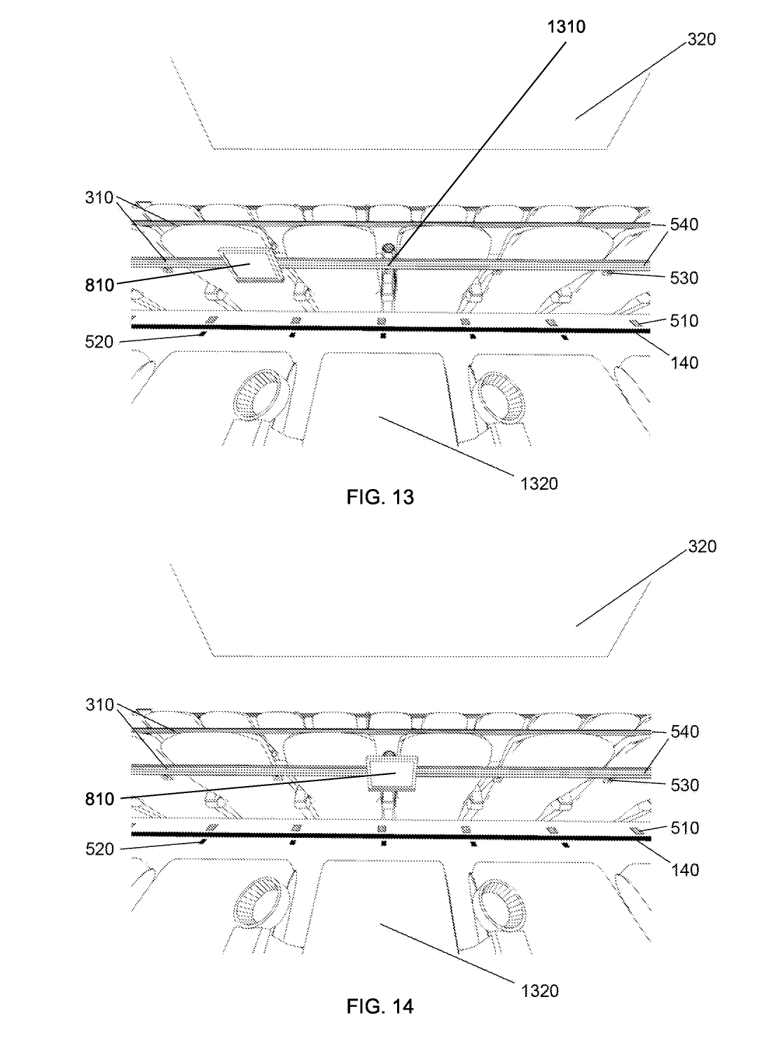

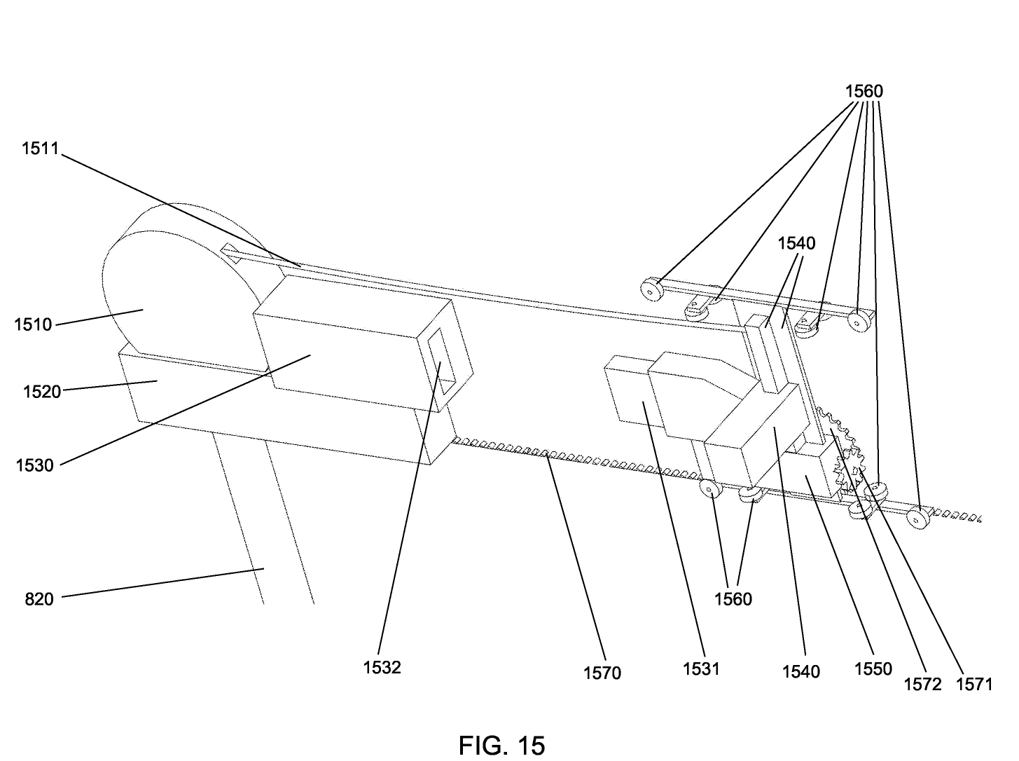

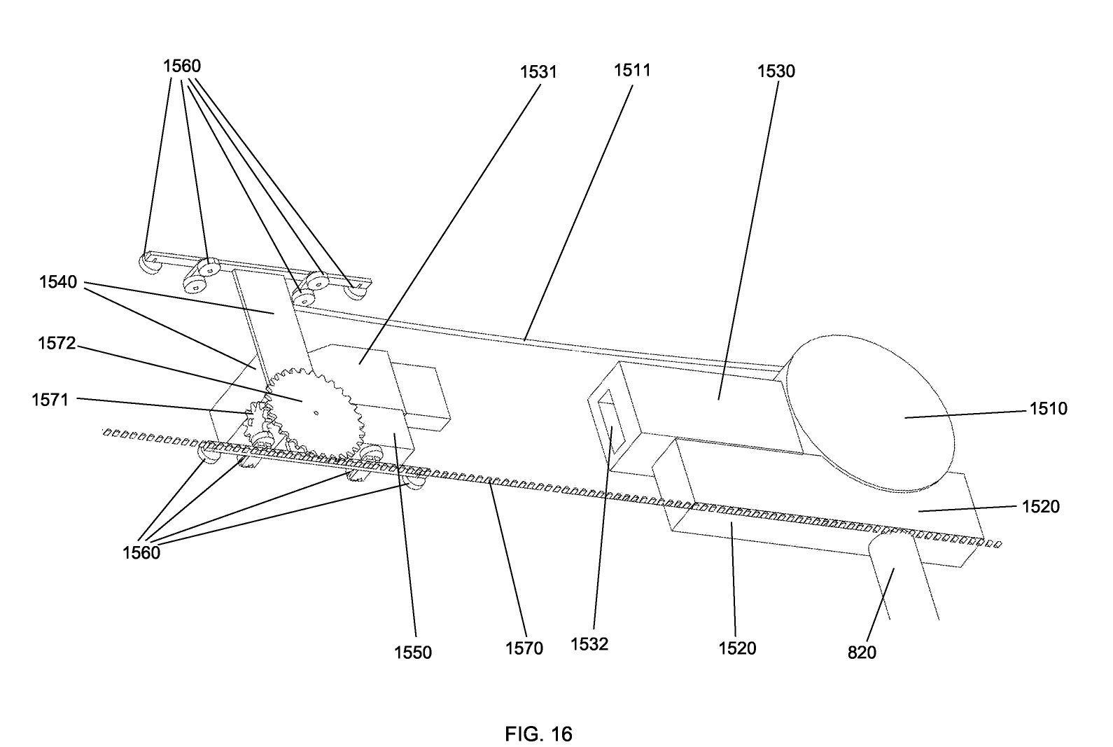

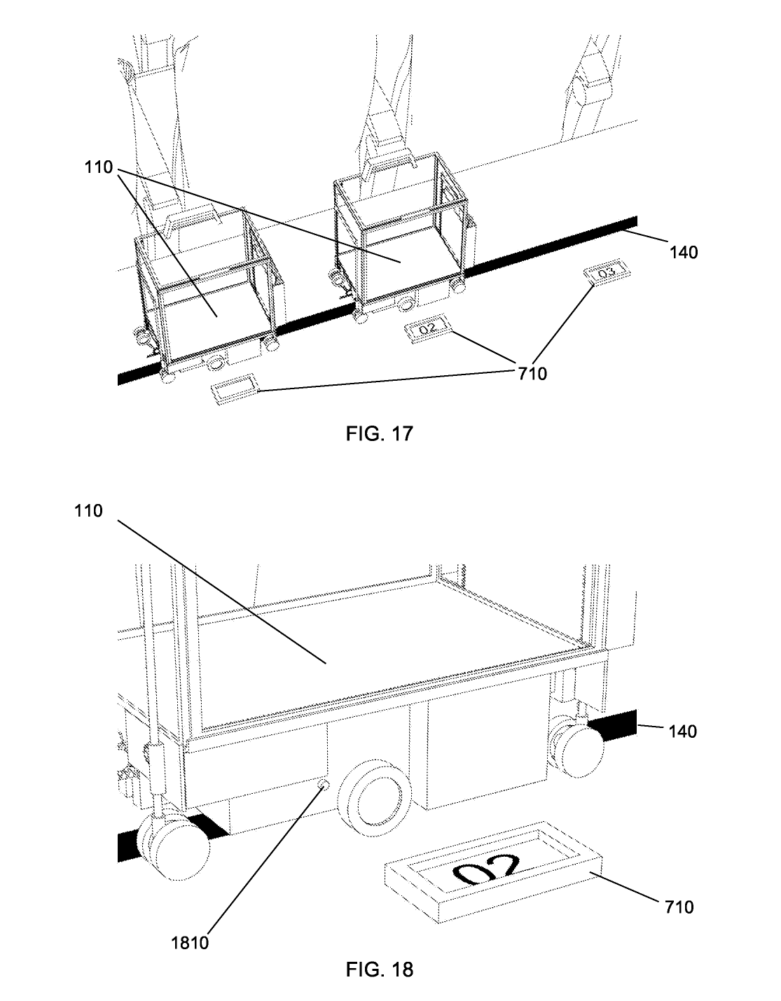

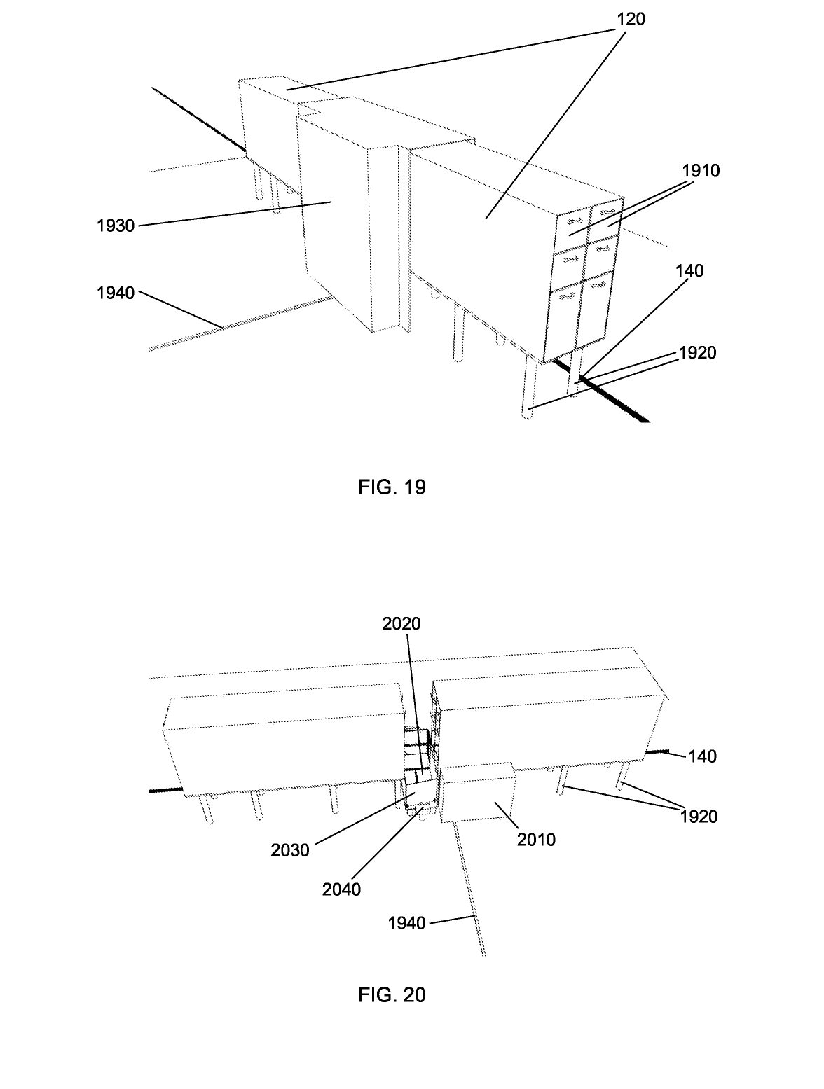

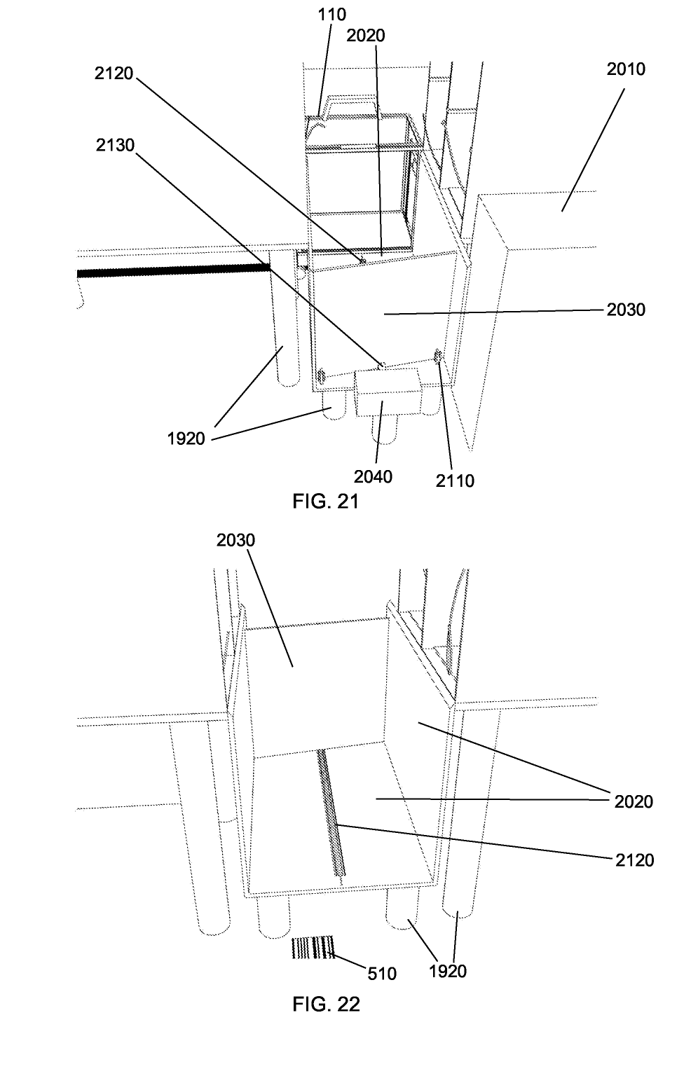

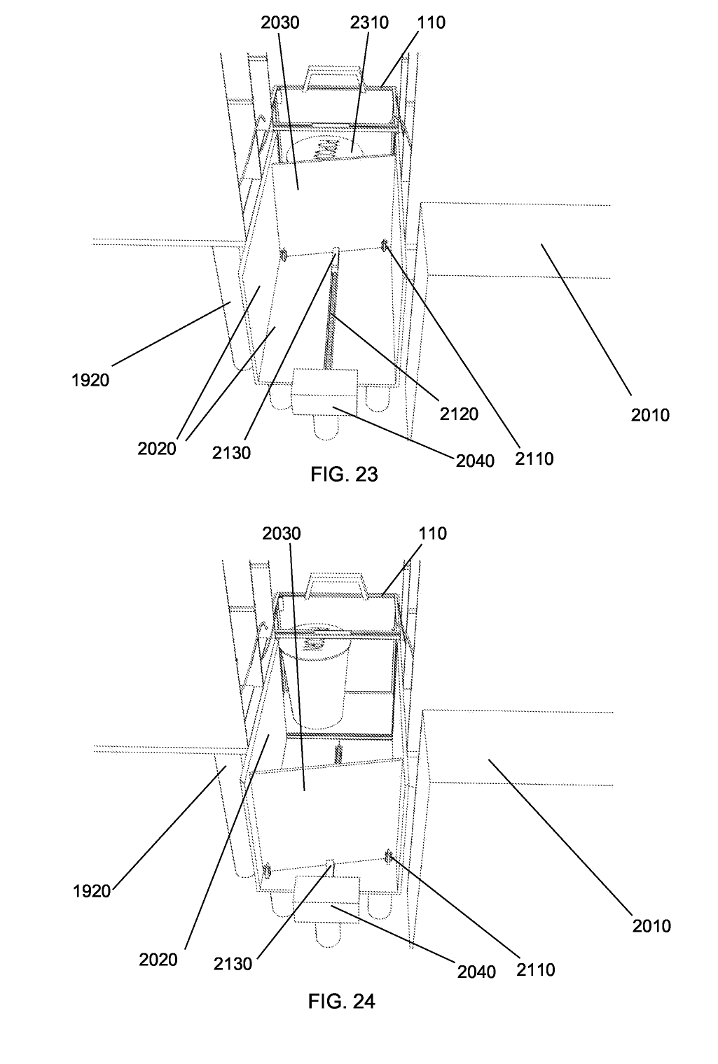

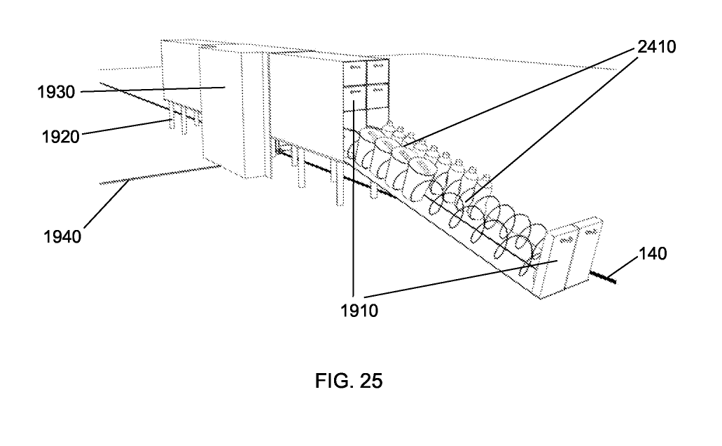

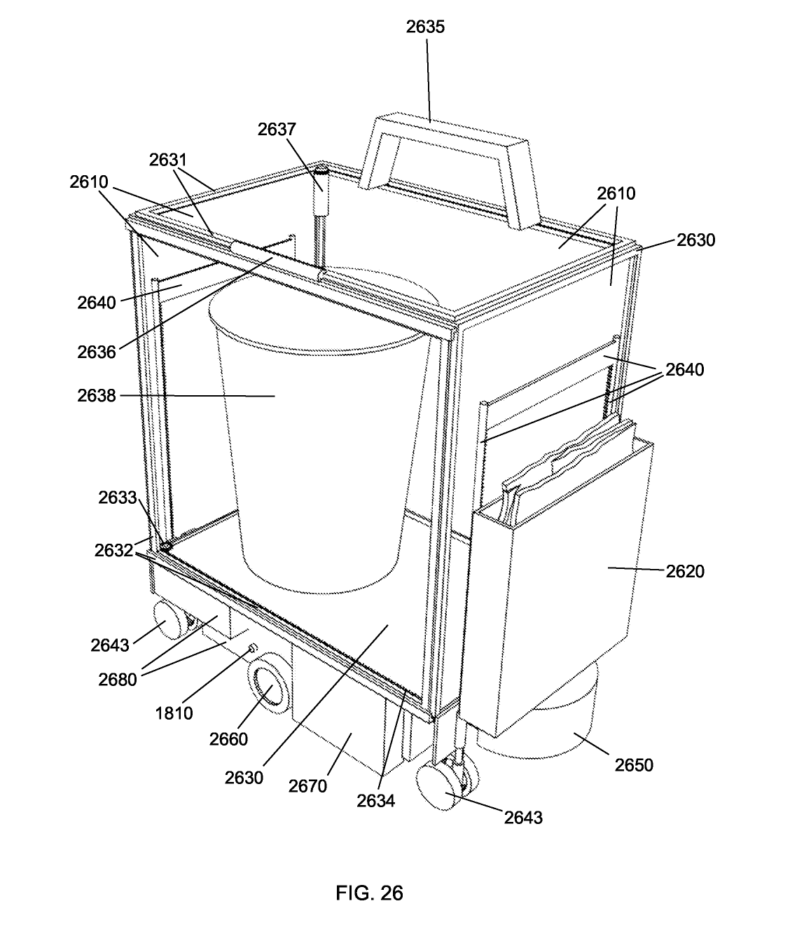

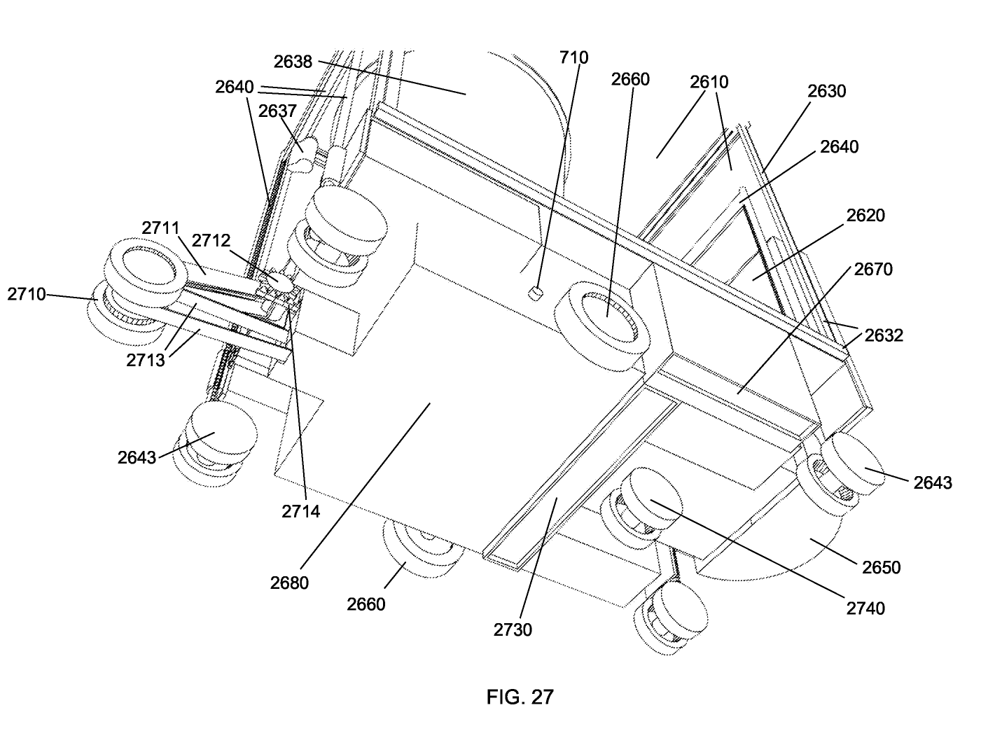

### MODES FOR CARRYING OUT THE INVENTION

There could be different embodiments of the system for sale and automatic delivery of products in movie theaters during film screening. The major considerations of its design are: type of a movie theater, and interrelation between a level of comfort and available funds.

### The Preferred Mode for Carrying Out the Invention

A system for products ordering.

Products are ordered by customers through the plurality of ordering devices (310) which are available to in every row of seats (130). Ordered products are loaded by vending machine (120) or manually into delivery containers (110). Delivery container (110) moves through the movie theater's auditorium along, guided by magnetic tape (140) and delivers ordered products into the area around the seat (1320) from which the order was made. Electric devices in the system receive electrical energy through batteries, or through cable (330) from a theater's electricity network.

In this description author could describe some elements in a singular form, but in a practical embodiment a plurality of similar elements could be used. The products ordering system, which in this preferred embodiment is a plurality of products ordering devices; products ordering device could be carried out as tablet computer (810) with touch screen (920) of size proportionally related to the size of the movie theater's chair. Tablet computer (810) in addition to standard features is equipped with the wireless connection module. An application for ordering products is installed and ran on this tablet computer (810). The application for ordering products shows customer list of products (931) available to purchase in the movie theater. Customer can choose preferred products from list (931) by pressing order button (935). Customer can choose quantity of the products by pressing arrows (937) above and under quantity field (936). If the customer has pressed order button (935) right after name of the product (932) from the products list (931), color of the line changes and if no quantity was chosen, quantity 1 is counted in total amount (933). The price of one unit of every according product is shown in price field (938). Total amount field shows total price of all selected items. Pressing reset button (939) on this page eliminates all chosen positions and changes total amount field (933) to basic zero. If proceed button (934) was pressed, a purchase finishing page (1010) opens on screen (920). Pressing reset button on purchase finishing page (1010) turns on a screen (920) previous page with products list (931). The purchase finishing page informs customer about total amount of costs (933) and products customer is going to purchase, also this page informs customer that he has to carry his payment card through card reader (940) to complete the purchase. Card reader (940) is attached, connected, and synchronized with tablet computer (810); sometimes customer may be required to enter a PIN code to authorize a transaction. After completing the purchase, customer sees gratitude/confirmation message (1110) and is offered to purchase more. If the answer is positive yes button (1111) was pressed), list of products takes place on screen (920). If the answer is absent for more than at least 15 seconds or negative(no button (1112) was pressed, products ordering device (310) moves to its start-charging position. If there was no customers actions noticed during 1 minute on every of purchase stages, products ordering device (310) moves to its start-charging position. When products ordering device (310) is moving or already stays on its start-charging position, it is available to be used by customers in the row. If a customer wants to purchase products from his seat (1320) he has to press call-the-ordering-device button (530) and wait until products ordering device (310) arrives to him. If customer is watching a movie with his head turned up, it takes him just one glance down cinema's screen (320) to notice a call-the-ordering-device button (530). Every sit has its related call-the-ordering-device button (530). If button (530) was pressed it sends a signal to products ordering device (310), asking it to arrive to seat where button (530) was pressed. Products ordering device (310) arrives one by one to every seat where call-the-ordering-device button (530) was pressed in order of priority to earlier pressed buttons (530). Products ordering device (310) stops movement when it reaches finish point (1310) in front of customer's seat (1320).

Products ordering device (310) moves along row of seats (130) using rack and pinion mechanism. Tablet computer (810) is attached to the rack and pinion system through connecting bars (1540). Pinion gear (1572) is rotated by motor gear (1571); motor gear (1571) is rotated by electric motor (1550). Pinion gear (1572) moves along rack (1570). Starts and stops of the movement and the control of the direction of the movement is coordinated through the microprocessor which receives wireless signals from the application for products ordering installed on tablet computer (810). Motor (1550) receives electrical energy from the electrical network of the movie theater through cable (1511) which is stored in cable storing box (1510) and is rolling in and out of it according to the movement of products ordering device (310). The motor (1550), the microprocessor, the motor gear (1571), the pinion gear (1572), the connecting bars (1540), the cable storing box (1510), the supporting wheels (1560) are made of raw materials and are located inside of plank (540) which is attached to row of seats (130). supporting wheels (1560) are designed with aim to provide stable movement of products ordering device (310), so that they are pressed to the walls of plank (540) but each of them is rolling around its axis, so that they do not limit the movement.

The odometer measures a distance passed by products ordering device (310). Distance to finish positions (3410) in front of every sit is stored in database of coordinating application on tablet computer (810). Coordinating application sends signal to the microprocessor of the rack and pinion mechanism to start movement in certain direction(left or right). Odometer sends information about passed distance to the coordinating application instantly, through means known by those skilled in the art. When distance to the destination is passed coordination application sends stop signal to the microprocessor which controls rack and pinion mechanism. The application database contains information about where products ordering device is located relatively to the zero point which is start charging position. So that, when application receives request to move to another seat, it calculates the distance by subtracting the destination distance from its current position distance(distance from zero point). If the result is more than zero, then products ordering device passes result distance in the direction of start-charging position. If the result is less than zero, then products ordering device passes result distance in the direction opposite to the start-charging position. The process iterates, to count the distance to every new position. The distance of start charging position is zero. The products ordering device performs request one by one, so that it doesn't move to a new request if it has not finished work with previous request. The finish of work with the request occurs when no buttons were pressed for at least 15 seconds on the gratitude/confirmation message (1110) page, or at least 45 seconds on all other pages. If the work with the current request was finished and there was no new requests received, the products ordering device moves to its start-charging position. Charging device (1530) is also located inside of plank (540), on the start-charging point.

The technology of carrying out products ordering device (310), particularly the application for ordering and synchronizing it with card reader (940) and with tablet computer (810), is analogical to those used in press-the-button-call-the-waiter, cash register and e-commerce systems and is apparent to those skilled in art. The means for coordinating the movement are well known to those skilled in the art.

The start charging point is located on the left or the right end of row of seats (130) and is a point where product delivery device (310) stay while it is not used. Charging device (1530) is mounted on assisting bar (1520) in a way, that when tablet computer (810) stays on its start-charging point, an electrical connector (1531) of tablet computer (810) is plugged to charging port (1532) of the charging device. Charging device (1530) itself receives electrical energy through a cable from the electricity network of the movie theater. Electrical connector (1531) connects with the battery of tablet computer (810) through the cable inside of the connecting bars (1540).

A system for automatic products delivery into an area around a customer's seat.

A system for automatic products delivery into an area around a customer's seat in preferred embodiment could be carried out as described below.

When a payment for an order was performed and accepted, the application for products ordering sends request for delivery of ordered products wirelessly to vending machine computer (2010). An application for coordinating loading and delivery processes is installed and ran on vending machine computer (2010). The application is customized to receive information from products ordering device (310) about which products, which number of products and into area around which seat (130) they should be delivered. The application is connected wirelessly to the coordinating devices on delivery containers (110). The application receives wirelessly information about every delivery container (110) current location. The application's database also contains information which delivery container (110) is free to perform a delivery. When request about ordered items is received, the application calculates whether the products requested could be loaded into one delivery container (110), or more. The application's database contains information about each products size, and about the size of delivery container (110) and also information about what products in which order and in which quantity could be put into the single delivery container (110). If products have to be loaded in more than one delivery container (110), than application divides that single order into plurality of orders with the same delivery destination. After that the application defines which delivery container (110) will perform a delivery. Delivery container (110) which is the closest to the loading spot and has no other orders to deliver is chosen by the application to perform the delivery. If all containers (110) are performing deliveries, the first delivery container (110) which becomes free is chosen to deliver the order which was received earlier than others in the queue in the application database. Delivery container (110) gets free status if it has been staying on order destination position (3410) for more than at least 60 seconds. If delivery container (110) gets free status, it is chosen to perform the next delivery or it is sent by the coordinating application to stay on the waiting spot. When delivery container (110) is chosen, the application identifies whether some of ordered products are to be loaded manually or all of the products of this order could be loaded automatically. The information about specifics of products is contained in the application's database. If there are products which should be loaded manually, the application sends a message to the mobile telephone of a person responsible for manual loading. The message contains information about on which manual loading spot (710), which products and which quantity of products should be loaded. The coordinating application sends the chosen container (110) to manual loading spot (710). Manual loading spot (710) is a surface on the theater's floor, where container stops to be loaded manually. Every manual loading spot (710) is marked with corresponding barcode (510), magnetic marker (520), and a frame with a number of spot which is made of raw materials. The person responsible for manual products loading loads products into container (110), when it is on manual loading spot (710). When the loading is performed, the person presses finish button (1810) which sends a signal to the application which means that the manual loading is completed. When the application receives information that the manual loading is completed, and there are products that are being loaded automatically, the application sends delivery container (110) to its destination. Vending machine loading spot is a surface on the floor of the theater in front of vending machine (120) where delivery container stays when vending machine loads products into it. If vending machine (120) is loading products to another delivery container (110), next delivery container (110) stays on the waiting spots. If delivery container (110) was already loaded with products manually, delivery container (110) passes vending machine loading spot without products having products loaded from vending machine (120). After the loading process was finished delivery container (110) starts moving to order destination (3410). The order destination is a spot (3410) in front of seat (1320) where the order was made. When delivery container (110) leaves the vending machine loading spot, the coordinating application sends delivery containers (110) to vending machine (120) in priority order: the first to the loading spot, and all others to the next positions on waiting spots. When delivery container (110) is located on the vending machine loading spot, the coordinating application starts to coordinate a loading process.

The coordinating application sends a signal to the delivery container (110) control device to open side door (2632) of delivery container (110).

The coordinating application sends a signal to a vending machine microprocessor to push at least one product which has to be loaded downwards on products loading platform (2020). The pushing of the product downwards is performed like a standard process for vending machines, well known to those skilled in the art.

When the product is on products loading platform (2020), the coordinating application sends signal to the microcontroller which actuates electric pushing motor located in motor box (2040). The motor rotates pushing screw (2120) counterclockwise, which moves smooth through the use of small wheels (2110) on the bottom of it, and is attached to a body of vending machine with handle (2130). So that when pushing screw (2120) is rotating counterclockwise, it moves pushing surface (2030) into the direction of the delivery container (110). The pushing surface moves the product inside of delivery container (110). When the screw (2120) reaches its maximum unscrewed position, products are inside of the delivery box. When the screw (2120) reaches its maximum unscrewed position, the microcontroller is programmed to tighten screw (2120), by motor rotating clockwise. When screw (2120) is maximally tightened, the microprocessor sends signal to the coordinating application, which means that the products pushing mechanism is ready to push new products. The process iterates for each product separately for necessary number of times. For example, first a bottle of coke is loaded into delivery container (110), after that the loading cycle repeats, and package of popcorn is loaded into the same delivery container (110).

Vending machine (120) needs to be filled up with the products, to replace products which were sold out or which expiration date passed.

The coordinating application database contains information about products present in vending machine (120) and information about expiration date of each product. When the last product of certain type is sold or product expiration date passed, the application sends command to the application installed on products ordering device (310) to make sold or expired products unavailable to choose in the products list. Also the coordinating application sends a message to the mobile phone of the person who is responsible for vending machine (120) refill. The message contains information about which products need to be refilled and in which amount. To accomplish the refill process, the person responsible for it takes out products storing shelves (1910) and fills them with products. After the filling, the responsible person puts the products storing shelves (1910) back into their basic position. After that the responsible person inputs into the coordinating application database the data about types and number of products which were loaded into vending machine (120). The coordinating application could be installed on few managing computers, which have their databases synchronized regularly. Vending machine (120) is isolated from the vending machine computer (2210) and from the external environment using vending machine cover (1930), and is supported with vending upholding columns (1920) which are made of the raw material. The energy to the electronic devices inside of the vending machine is provided through electricity supply cable (1940).

Technologies of carrying out vending machine (120), the vending machine computer (2010) and coordinating application are well known to those skilled in corresponding arts.

Delivery container (110) is an automated guided vehicle which transports ordered products from vending machine to the area around the seat where the order was made. Container body (2630) is constructed of a frame made of raw materials and transparent walls, which are made of plastic or another transparent material. Delivery container (110) is equipped with side (2632) and upper (2631) doors, which are also made of transparent material. The transparency is not necessary but is preferred in order exhibit products (2638) which are transported. Side door (2632) opens through a use of pinion (2633), which, while being rotated clockwise and counterclockwise by the motor, moves rack (2634) on the bottom of side door, so that doors opens and closes correspondingly. The commands for opening and closing are sent by central coordinating application to the corresponding microcontroller on delivery container (110). Upper door (2631) is locked with an electromagnetic lock (2637), which is constructed in a way apparent to a person skilled in the art. The coordinating application sends signal to unlock lock (2637) when delivery container (110) arrives to its destination. The coordinating application sends signal to close lock (2637) again when new products are loaded. When unlocked, door (2631) could be opened using a door handle (2635), mounted on it (2631). Upper door (2631) could be moved up and down because it is attached to roller linkage veil (2636). Doors, walls, and frames to which they are attached, together are referred to as container body (2630). Also tissue pocket (2620) is mounted on container body (2630). It is refilled with paper tissues manually, when responsible person thinks the refill is necessary. If one or both doors are open, pressing manual loading finish button (2680) will close both doors. If both doors are closed, pressing manual loading finish button (2680) will open both doors. Delivery container(110) is an automated guided vehicle, which uses magnetic tape (140), markers (520) and barcodes (510) on the floor of the movie theater as a guidance marks and is coordinated by the application installed on its own microcomputer and by the central coordinating application. Marker scanner (2730) scans magnetic tape (140) and magnetic markers (520) on the theater's floor. Barcode scanner (2670) scans barcodes (510) on the theater's floor. Barcodes (510) contain information about an action which is required to perform in a corresponding point, for example to move down the stair, or to stop on the destination point. Obstacle scanner is used to identify obstacles on the way of delivery container (110). Information scanned by all of these three scanners is sent to the delivery container microcomputer, which is synchronized with the central coordinating application in order to manage the movement process and other actions performed by delivery container (110).

Marker scanner (2730) scans magnetic tape (140) and markers (520) while moving along the theater's floor. Delivery container's microcomputer counts a number of markers (520) identified by scanner (2730) on the route from the vending machine loading spot to order delivery destination (3410). Because of counting identified markers, delivery container's microcomputer and the coordinating application both contain information about current location of delivery container (110) on its route. Barcodes (510) are scanned when delivery container verifies its location. Delivery container (110) verifies its location, before performing a required action, comprising actions to turn, to move downstairs, to move upstairs, and to stop at its destination point (3410).

Obstacle scanner (2650) identifies obstacles on the way of delivery container (110); when an obstacle is identified, movement stops. If obstacle is continuously identified for at least 30 seconds, the central coordinating application sends a message to the mobile phone of a person who is responsible for maintaining the system. The mobile telephones of persons responsible for maintaining the system are inputted manually into the coordinating application. The message contains information that there is a stable obstacle for container which is moving to the seat of certain number or which is moving back from the certain seat; and information about location relatively to the nearest row of seats is also contained. When obstacle is eliminated, delivery container (110) continues moving its route. The technology of carrying out an automated guided vehicle which moves along magnetic tape (140) by predefined routes, with the help of magnetic markers (520) and barcodes (510), and technology of management of its movement is well known by those skilled in the art.

Electric motors transform electrical energy from a battery, which is stored in battery box (2830), to mechanical energy and transmits this energy to main wheels (2660), backside supporting wheel (2710) which rotate and provide directed movement of delivery container (110), and also to other mechanisms used in construction of delivery container (110). Delivery container (110) has two main wheels (2660). Both main wheels (2660) rotate in the same direction with the same speed, if delivery container (110) moves forward or backward. If delivery container (110) has to make right or left, turn, one of main wheels (2660) does not rotate, and only another is turning so that, delivery container (110) is turning to the right or to the left. Lifting wheels (2643) are caster wheels, mounted on lifting wheels rack (2640), which support delivery container (110) in its position and prevent delivery container (110) from overturning. The movement of delivery container (110) up and down stairs is performed with the support of lifting wheels (2643). The process of moving up and down stairs looks as following: if the stair-up or -down marker (520) is identified(delivery container's microcomputer counts every scanned on its route marker (520); coordinating application's database contains information about the action container (110) has to perform on which marker (520); and when, for example, container (110) has to perform the downstairs movement on the fifth marker, then if fifth marker is identified(counted), barcode scanner (2670) scans corresponding barcode (510) to verify whether it is the fifth marker location or not; if barcode (510) states another location, for example the sixth marker, delivery container (110) repositions: it moves back to the fifth marker and then verifies is it fifth marker or not; if it is not the fifth marker the repositioning process iterates; if barcode (510) states that it is the fifth marker and the action to be performed on the fifth marker is also confirmed by barcode (510) scanning, delivery container (110) performs required action, in this case, the downstairs movement.

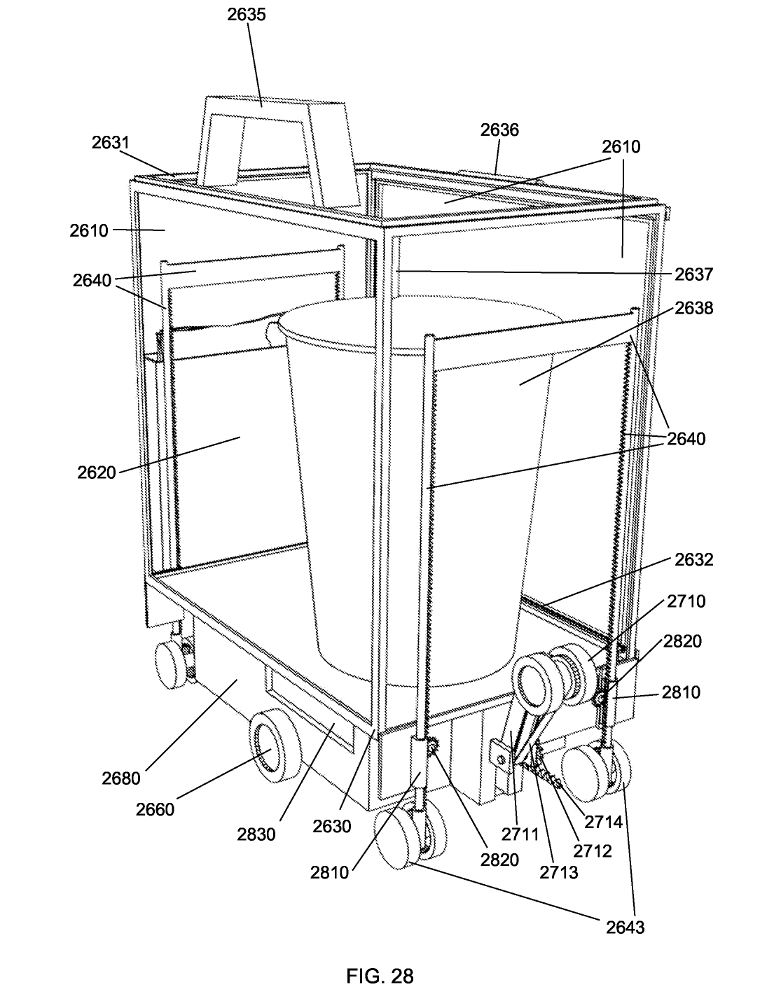

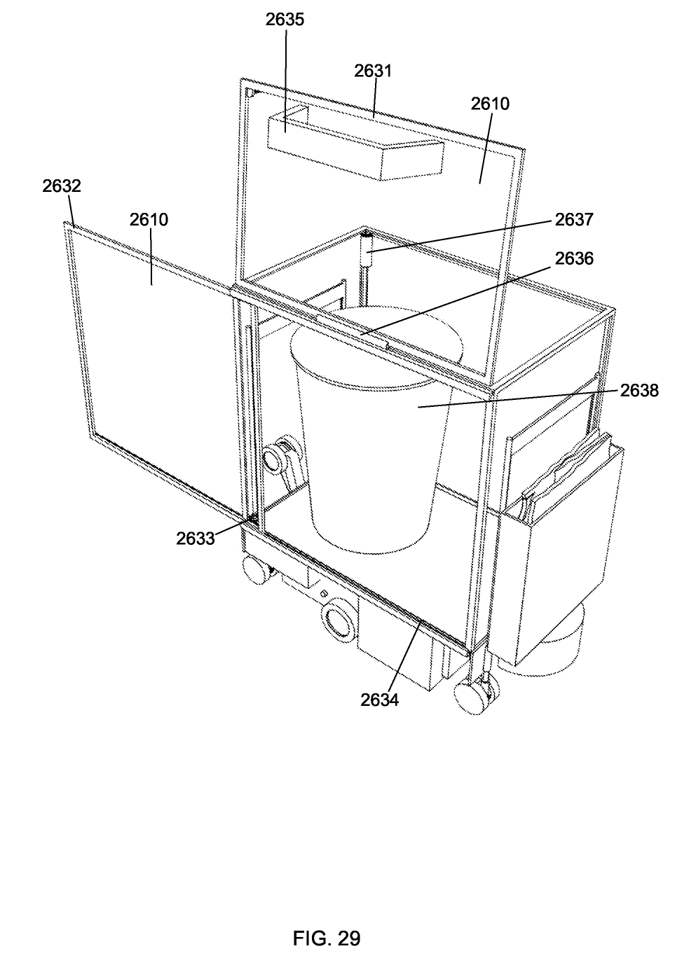

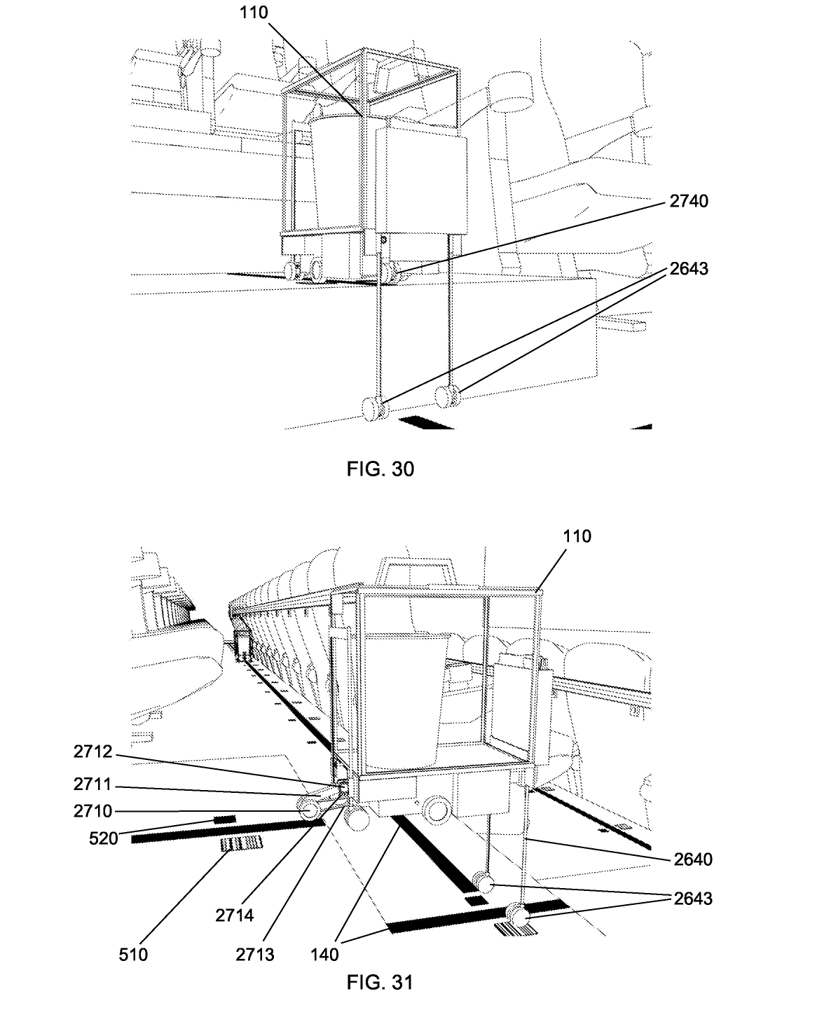

To move downstairs delivery container (110) stops on the edge of the stair in the way that front pair of lifting wheels (2643) are hanging off the edge of the stair, but backside supporting wheel (2710), main wheels (2660) are still on the upper stair supporting the front side of delivery box and preventing it from falling or overturning. When this position is verified in the coordinating application, the application sends the movement down command to the lifting wheels microcontroller. If the command is received, lifting wheels pinions (2820) start rotating and moving lifting wheels rack (2640) down, so that the delivery box is in takes the position illustrated in FIG. 30. Lifting wheels racks (2640) are connected to containers body (2630) through linkages (2810), which are made of raw materials. Lifting wheels pinions (2820) are rotated by motors which are controlled through at least one microcontroller. Microcontroller controls the number of turns of pinion (2820), which are needed to reach the floor. This number is predefined in the database of the coordinating application and is customized for every certain theater. If front lifting wheels (2643) have reached the floor, the lifting wheels microcontroller sends corresponding informational signal to the coordinating application, which means that front lifting wheels (2643) have reached the floor. If this signal is received by the coordinating application, it sends signal to delivery container (110) to move forward; if delivery container's microprocessor receives that signal, it rotates backside supporting wheel (2710) from passive to active position. Backside supporting wheel (2710) is supposed to move delivery container (110) to the position illustrated on FIG. 31. The backside supporting wheel (2710) is attached to delivery container (110) with backside wheel handle (2711). Backside supporting wheel (2710) turned up and down through the use of rack (2714) which is moved back and forth by the motor which rotates pinion, connected to rack (2714). Rack (2714), while moving back and forth, rotates another pinion (2712) which is attached to backside wheel handle (2711), so that backside supporting wheel (2710) is moved from a passive position illustrated on FIG. 28 to the active position illustrated on FIG. 30. The passive position means that backside supporting wheel (2710) is turned up and does not participate in the movement process. When backside supporting wheel (2710) is in the active position, it (2710) touches the surface of the theater's floor and, while rotating, it moves delivery container (110) forward, and supports the back side of delivery container (110). Backside supporting wheel (2710) receives mechanical energy from the motor through rotating chain (2713).

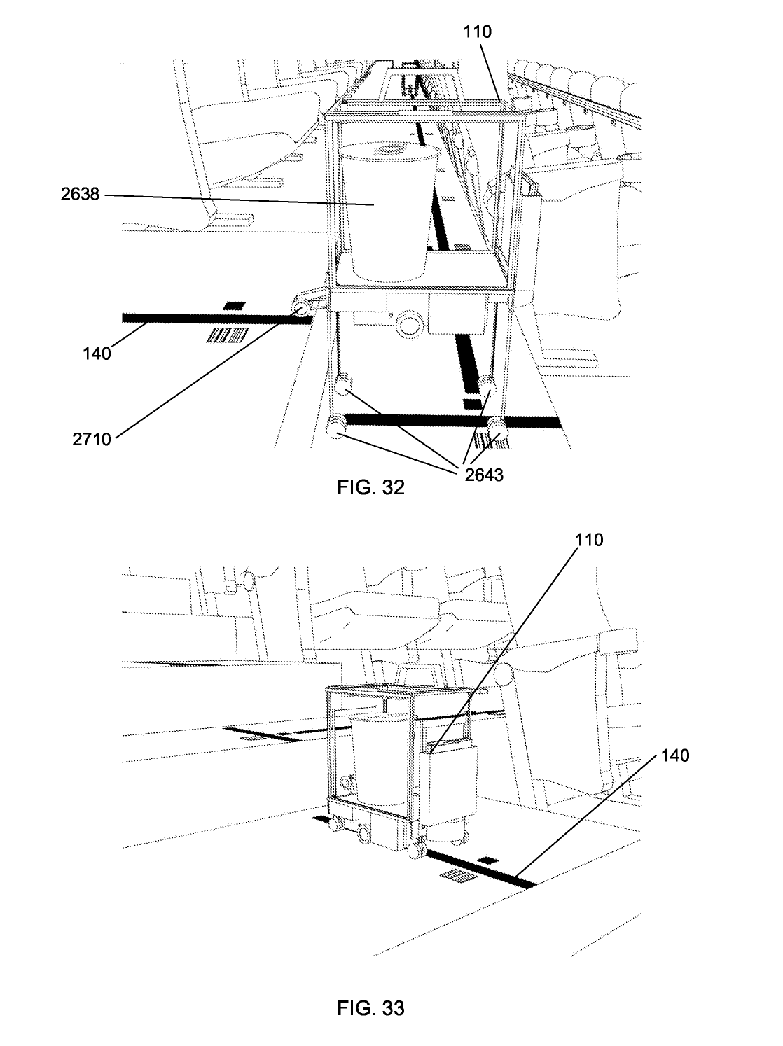

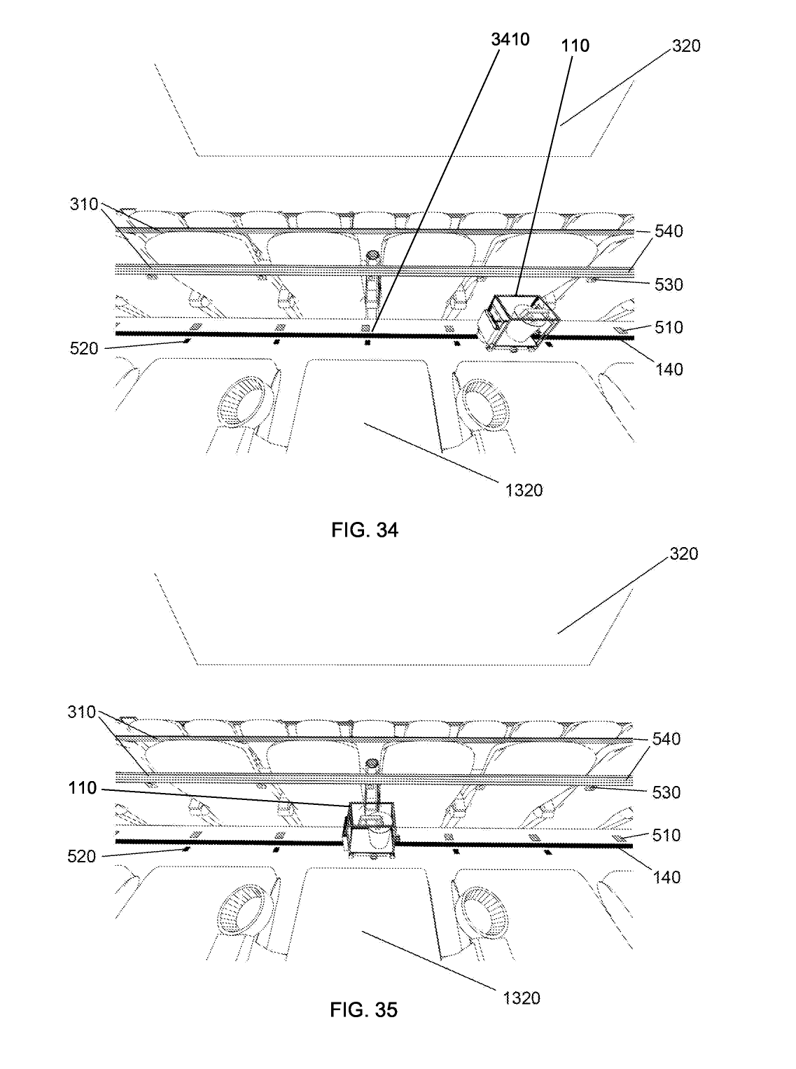

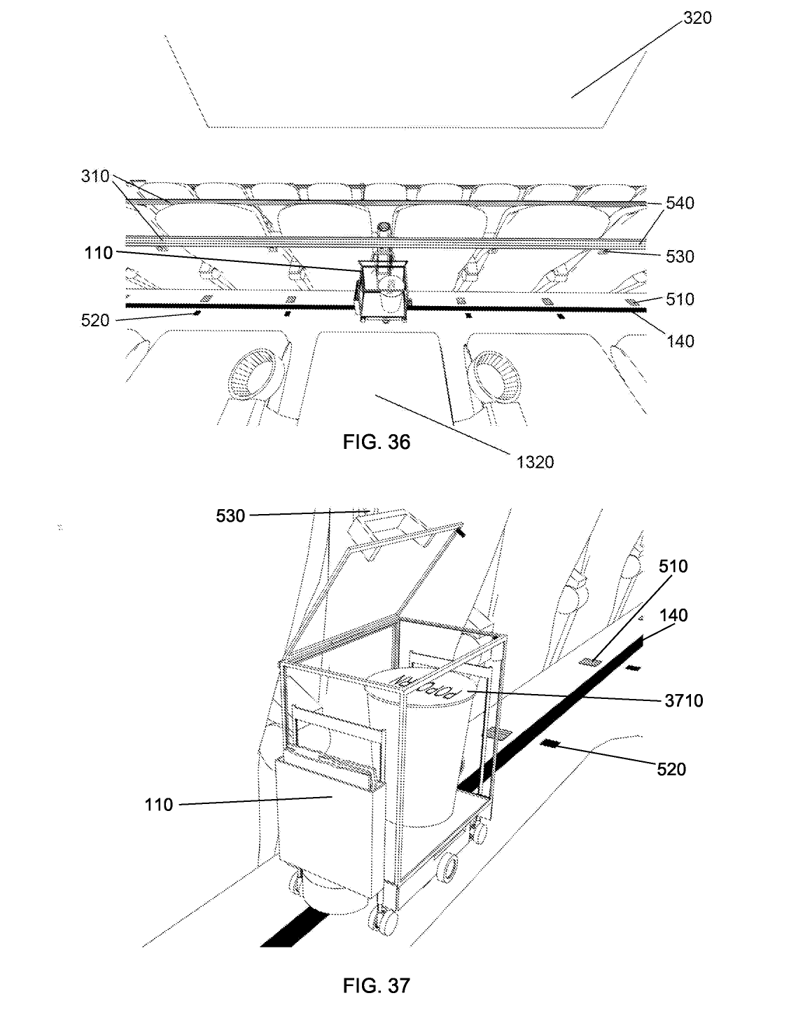

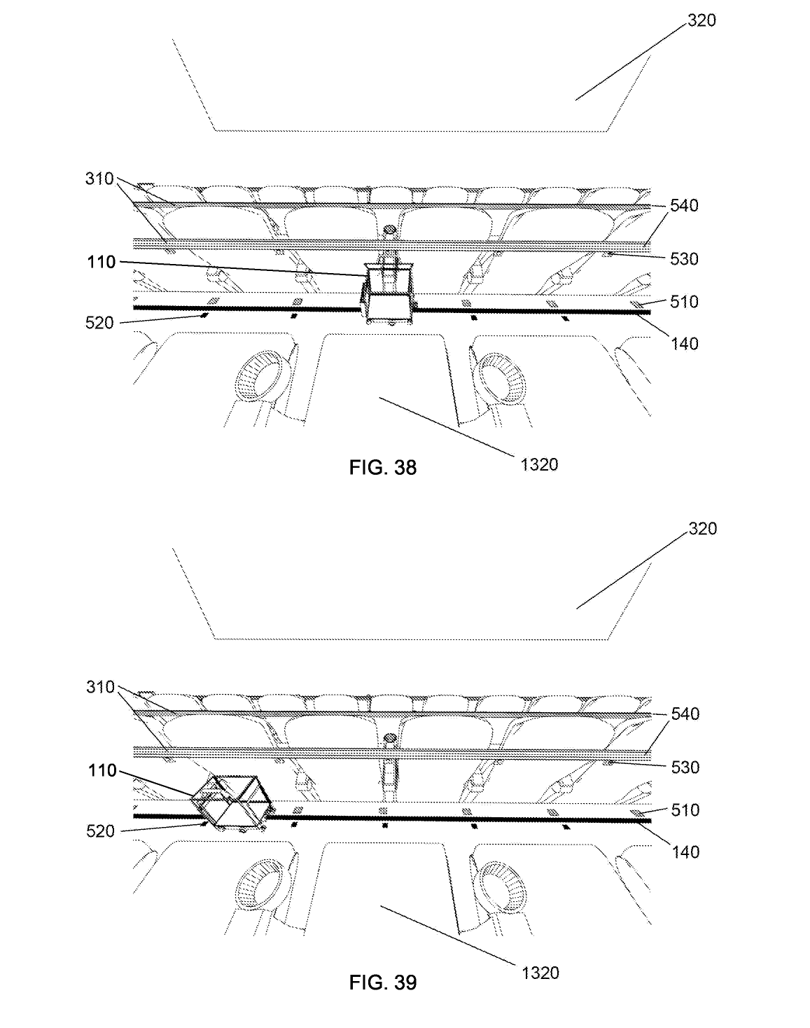

If backside supporting wheel (2710) rotates, while being in the active position, it moves delivery container (110) to take position illustrated on FIG. 31. When delivery box is in position, as illustrated on FIG. 31, the analogical(through rack and pinion mechanism) process of the down movement repeats with back lifting wheels (2643), as it was with front wheels (2643). Then delivery container (110) takes the position, as illustrated on FIG. 32.

When both back and front lifting wheels stay on the lower stair, as illustrated on FIG. 32, backside supporting wheel (2710) makes number of turns enough to move delivery container (110) off the upper stair completely.

When delivery container is off the upper stair, the coordinating application sends racks-up command to front and back lifting wheels microcontroller; the command starts the up-movement of racks (2640), so that motors rotate lifting pinions (2642), until the delivery container (110) takes the position, as illustrated on FIG. 33. Then delivery container (110) continues the forward movement.

If marker (520) and barcode (510), which require a turn where identified and verified on the route, delivery container (110) performs the turn action, using main wheels (2660), as it was described before.

If marker (520) and barcode (510) requiring a turn where identified and verified on the route, delivery container (110) performs the up-stair movement. The up-stair movement is performed in the way reverse (like a video clip played in reverse way) to the described before down-stair movement.

To move upstairs delivery container (110) stops near the beginning of the stair. Backside supporting wheel (2710) is in passive position (turned up). When this position fixes in the coordinating application database, lifting racks (2640) are being turned up in order to turn up container body (2630). When container body is turned up to the level of the upper stair, backside supporting wheel (2710) takes active position(turns down). So that, backside supporting wheel (2710) touches the surface of the upper stair and can provide directed movement to delivery container. Backside supporting wheel (2710) moves small, but enough to provide more stable support, distance forward. Then back lifting wheels (2643) are turned up from the floor of the lower stair. If they are turned up to the level of the upper stair, backside supporting wheel (2710) moves forward until only front lifting wheels (2643) stay on the lower stair, and almost whole container body is on the upper stair. After that, front lifting wheels (2643) are turned up to the level of the upper stair, and container (110) continues movement along its route.

### Alternative Modes for Carrying Out the Invention

In due to achieve high cost efficiency, the preferred embodiment of system for products ordering contain one products ordering device with a one ordering interface available for use in each of rows of seats. But system for products ordering could also be carried out as plurality of ordering devices available for use in each of row of seats in the movie theater auditorium.

Ordering interfaces could be carried out as a minicomputer with a touch screen, located on the armrest of the seat, or on the back of the seat in front of the customer. Ordering interface could also be carried out or as simpler electronic device, for example only a few buttons, or a printed brochure with a few buttons for ordering only a few products (as some vending machines have).

Buttons for calling a products ordering device could be mounted on an armrest of a seat, on a floor around the seat, on a surface under the seat, or on a back side of the seat. The number of buttons could also vary.

The presence, the size, and the type of the screen of the ordering interface may vary due to available costs.

The system for products ordering could have banknote acceptor synchronized with it, in order to receive cash payments and to check whether banknotes are genuine or counterfeit.

A payment for products could be performed with internal theater's magnetic cards, given to every visitor. Such magnetic cards records all order made with it. Before leaving the movie theater customers are required to check and leave their cards on a cash register, and if they ordered anything with a card they pay for it on the cash register, before leaving the movie theater.

An electronic device appropriate for running an interface for ordering products could be carried out as screen for displaying information with a keyboard, or as a touch screen, where the inputted information is wirelessly sent on the central computing unit which is analyzing information and sending response information to be displayed on the screen.

A system for automatic products delivery into an area around a customer's seat.

The process of loading products into the delivery container could be carried out only manually, without vending machine.

There could be a plurality of manual loading spots, including an embodiment where manual loading is possible near a few or near every row of seats, so that the delivery container delivers products only among seats in the few rows or even a single row.

The vending machine could be carried out in many different ways, using vending technology the most appropriate for the certain theater. Delivery containers could move through the movie theater auditorium using a system of on-floor rails. Delivery container is attached to the rail in a way that does not limit its movement abilities, but makes hard for a person to take away or misdirect the delivery container.

Delivery container could be carried out automated guided vehicle guided with laser navigation, or another navigation system, which is the most appropriate for a certain movie theater.

Different mechanisms could be used to provide movement of the delivery container up and down the stairs. These could be ramps, or hydraulic or pneumatic scissor lift platforms mounted on each stair. This also could be a lift system, mounted on the theater's floor, similar to those used in lift skiers up on the mountain; but in this case, lift of similar technology would transport containers along the stairs. To provide more free space, lift of similar technology could also be attached to the theater's film screening auditorium. In that case, delivery container would have caster wheels mounted on its side walls; caster wheels, or another mechanism, will provide smooth movement along the wall of the auditorium (while being transported).

Also delivery container could use continuous tracks(caterpillar tracks) instead of wheels, in order to move up and down the stairs. But this system could have obstacles in practical use in many theaters, because of inappropriate sizes of stairs, of the delivery container and of a space between rows of seats.

Delivery containers could partly or fully move under the floor of the theater's auditorium. The delivery process would be faster in that case, but the installation of such system would require much more costs. Vending machine could also be installed under the floor, if a theater requires such decision for some reasons.

The space under seats in a row could be modified in a way to organize a path for the delivery container under seats, invisible for an eye of a customer.

Decisions which propose to hide elements of the system from a person's eye provide more visual comfort for a customer, but also they provide less promotion for the system.

The function of delivery container could be performed by a small delivery helicopter, or another flying machine, which starts and grounds vertically. This decision increases the cost of the system but could be treated as stylish, original and simple to pass obstacles, for example stairs. In addition, this machine could only pass stairs while in the air, and move other part of distance on wheels.

Different types of delivery containers could be used for the delivery of different products. For example, smaller container could be used for transporting sweets or chewing gum, and bigger containers could be used to transport a big package of popcorn. Bigger containers could be used for delivery of few products to one delivery destination.

Delivery containers could be used as moving sale-vending machines; which drive between rows of seats, promoting possibility to buy products during a film screening; A customer could request a container to arrive to him; when the container comes to the customer, he/she could pay for products in the container, then take them out and consume.

A screen of a products ordering device could be programmed to show advertisement of the system for sale and automatic delivery of products in movie theaters during a film screening.

Advertisement of the system could be installed on seats, on the floor, on containers, and in any reasonable position. The advertisement could be shown on the big cinema's screen before a film screening.

Any system for ordering/purchasing products before a film screening and having them delivered during a film screening could be carried out.

Manual loading spots and/or vending machine could be located outside of the auditorium where a film is screening, for example in a theater's buffet. This makes a process of loading products and maintaining of the system easier and faster for the movie theater workers.

What is claimed is:

1. A method comprising:
Automatic transportation of at least one product to at least one product destination area, said automatic transportation comprising performance by machine transporting means, said automatic transportation takes place in a movie theatre auditorium during a film screening.

2. The method of claim 1, further comprising each seat in said theatre auditorium comprising one said product destination area, said product destination area comprises space in a range of two meters from said seat in every direction from said seat.

3. The method of claim 1, further comprising said machine transporting means are able to perform said automatic transportation to every product destination area located in said movie theatre auditorium.

4. The method of claim 1, wherein a customer is sitting on said seat, said customer typically has ability to continue sitting on said seat without need to get up from said seat.

5. The method of claim 4, wherein said automatic transportation partly takes place in space under floor in said movie theatre auditorium or said automatic transportation completely takes place in said space under said floor in said movie theatre auditorium.

6. The method of claim 5, wherein said customer is sitting on said seat, said customer is typically able to continue watching said movie screening without said customer being visually distracted by said automatic transportation.

7. The method of claim 6, wherein said customer is sitting on said seat, said customer is typically able to continue to listen to an audio of said movie screening without said customer being distracted with sounds created by said automatic transportation.

8. The method of claim 1, wherein a customer is sitting on said seat, said customer is typically able to continue to listen to an audio of said movie screening without said customer being distracted with sounds created by said automatic transportation.

9. The method of claim 8, wherein said automatic transportation partly takes place in space under floor in said movie theatre auditorium or said automatic transportation completely takes place in said space under said floor in said movie theatre auditorium.

10. The method of claim 1, wherein a customer is sitting on said seat, said customer is typically able to continue watching said movie screening without said customer being visually distracted by said automatic transportation.

11. The method of claim 10, wherein said automatic transportation partly takes place in space under floor in said movie theatre auditorium or said automatic transportation completely takes place in said space under said floor in said movie theatre auditorium.

12. The method of claim 1, further comprising a customer using product ordering device, said customer is ordering at least one product while said customer is sitting on said seat in said movie theatre auditorium during said film screening.

13. The method of claim 12, wherein a button is used by said customer to start a products ordering process.

14. The method of claim 12, further comprising said customer using a device for receiving a payment, said customer is paying money for at least one product while said customer is sitting on said seat in said movie theatre auditorium during said film screening.

15. The method of claim 1, further comprising a customer using a device for receiving a payment, said customer is paying money for at least one product while said customer is sitting on said seat in said movie theatre auditorium during said film screening.

16. The method of claim 1, wherein automatic product loading machine loads machine transporting means with at least one ordered product.

17. The method of claim 1, wherein person is loading machine transporting means with at least one ordered product.

18. The method of claim 1, wherein said automatic transportation partly takes place in space under floor in said movie theatre auditorium or said automatic transportation completely takes place in said space under said floor in said movie theatre auditorium.

19. An apparatus comprising:
A plurality of product destination areas, and machine transporting means for performing automatic transportation of at least one ordered product by a customer to at least one product destination area of said plurality of product destination areas, said plurality of product destination areas is located in movie theatre auditorium during film screening.

20. The invention of claim 19, further comprising said product destination area is space within 2 meters range from said customer in any direction from said customer.
